(19) United States
(12) Patent Application Publication
(10) Pub. No.: US 2025/0209292 A1
(43) Pub. Date: Jun. 26, 2025

(54) ELECTRONIC DEVICE

(71) Applicant: STMicroelectronics International N.V., Geneva (CH)

(72) Inventor: Philippe ALARY, Puyloubier (FR)

(73) Assignee: STMicroelectronics International N.V., Geneva (CH)

(21) Appl. No.: 18/981,937

(22) Filed: Dec. 16, 2024

(30) Foreign Application Priority Data
Dec. 22, 2023 (FR) FR2315227

(51) Int. Cl. G06K 19/07; G06K 7/10

(52) U.S. Cl. CPC G06K 19/0723; G06K 7/10297; G06K 19/0718

(57) ABSTRACT

An electronic device, such as a smart card, includes a first secure element configured to implement a transaction in response to received data, and a second secure element configured to receive the same data as the first secure element and perform an operation which can control another electronic circuit.

### PRIORITY CLAIM

This application claims the priority benefit of French Application for U.S. Pat. No. 2,315,227, filed on Dec. 22, 2023, the content of which is hereby incorporated by reference in its entirety to the maximum extent allowable by law.

### TECHNICAL FIELD

The present disclosure generally concerns electronic devices and circuits and, in particular, electronic devices and circuits configured for implementing a transaction.

### BACKGROUND

There exist a multitude of electronic devices and circuits configured for implementing transactions. Certain transactions require the implementation of circuits which perform the management of sensitive or secret data.

It would be desirable to be able to improve, at least partly, certain aspects of electronic devices configured for implementing a transaction comprising sensitive data.

There exists a need for electronic devices configured for implementing a transaction comprising sensitive data, and to securely using this sensitive data for an additional function.

There is a need in the art to overcome all or part of the disadvantages of known electronic devices configured for implementing a transaction comprising sensitive data.

### SUMMARY

An embodiment provides an electronic device comprising two secure elements configured to receive the same sensitive data.

An embodiment provides an electronic device comprising: a first secure element configured for implementing a transaction; and a second secure element configured to receive the same data as the first secure element, and to control a first electronic circuit.

According to an embodiment, the first and second secure elements are configured to receive data in wired fashion.

According to an embodiment, the first and second secure elements are coupled to same connection terminals.

According to an embodiment, the first and second secure elements are configured to receive data by a wireless communication.

According to an embodiment, the first and second secure elements are connected to a same antenna.

According to an embodiment, the wireless communication is a near-field communication.

According to an embodiment, the first secure element comprises a first reference terminal coupled to a second reference terminal of the electronic device via a first diode.

According to an embodiment, the first diode is a Schottky-type diode.

According to an embodiment, the second secure element comprises a third reference terminal coupled to the second reference terminal of the electronic device via a second diode.

According to an embodiment, the second diode is a Schottky-type diode.

According to an embodiment, said first circuit comprises a fourth terminal coupled to said third reference terminal via a capacitor.

According to an embodiment, said first electronic circuit comprises a second circuit and a third circuit for driving said second circuit.

According to an embodiment, the second electronic circuit is selected from the group comprising: a display screen, a fingerprint sensor, a light-emitting diode, a sensor control device, and a memory.

According to an embodiment, said device is selected from the group comprising: a bank card, a smart transport card, a car key, an access control card.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an embodiment of an electronic device;

FIG. 2 shows timing diagrams illustrating the operation of the embodiment of FIG. 1;

FIG. 3 shows a more detailed example of the embodiment of FIG. 1; and

FIGS. 4A and 4B show diagrams illustrating an advantage of the embodiment of FIG. 3.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

The embodiments described hereafter concern an electronic device configured for implementing a transaction manipulating sensitive data. What is referred to here as sensitive data means one or a plurality of data items, having the access thereto restricted to one or a plurality of persons and/or one or a plurality of electronic devices. Such a transaction is, for example, a bank transaction.

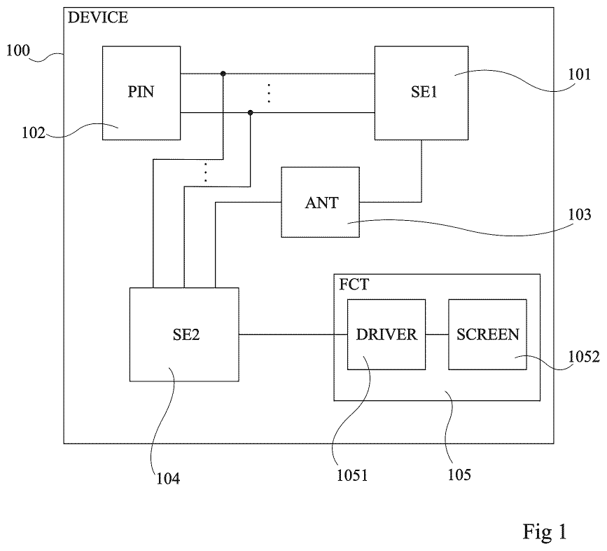

The embodiments described hereafter comprise a first secure element (SE) configured for implementing said transaction, but also a second secure element configured to securely implement one or a plurality of additional functions of the electronic device by using data of said transaction. The two secure elements are distinct and are configured to receive the same sensitive data. The advantages and details of these embodiments are described in relation with FIGS. 1 to 4.

FIG. 1 shows, very schematically and in the form of blocks, an electronic device 100 (DEVICE) according to an embodiment.

Electronic device 100 is configured for implementing a transaction, and in particular, a transaction using sensitive data with another electronic device. The other electronic device is generally external to device 100. For this purpose, electronic device 100 comprises a first secure element 101 (SE1) configured for implementing the transaction. This first secure element is, for example, configured to implement a software application securely executing the transaction.

To implement the transaction, device 100 further comprises connection terminals 102 (PIN) and/or an antenna 103 (ANT) enabling to establish a communication with the other electronic device.

According to an example, connection terminals 102 enable the electronic device to implement a wired communication with the other device. Connection terminals 102 are coupled to the first secure element 101, and enable to supply data, for example, sensitive data, thereto, to implement the transaction.

According to an example, antenna 103 enables the electronic device to implement a wireless communication with the other device. According to an example, antenna 103 may enable to implement a near-field communication (NFC). Like connection terminals 102, antenna 103 is coupled to the first secure element 101, and enables to supply data, for example, sensitive data, thereto, to implement the transaction.

Thus, when the electronic device comprises terminals 102 and antenna 103, the first secure element 101 may, indifferently, implement the transaction by using terminals 102 or antenna 103.

Device 100 further comprises a second secure element 104 (SE2) configured to receive the same information, that is, the same data, for example, the same sensitive data, as the first secure element 101, and also to implement an additional functionality of electronic device 100. More particularly, secure element 104 is coupled to terminals 102 and/or to antenna 103 in the same way as the first secure element 101.

To implement the additional functionality, electronic device 100 further comprises a circuit 105 (FCT), implementing this functionality, which is controlled by secure element 104. Circuit 105 may, for example, be a display, such as a display screen or light-emitting diodes, a biometric control circuit, such as a fingerprint sensor, and so on. According to another embodiment, circuit 105 may be a sensor control device, or a memory.

According to the specific example shown in FIG. 1, circuit 105 comprises a driver circuit 1051 (DRIVER) and a screen 1052 (SCREEN) configured to display one or a plurality of pieces of information concerning the transaction.

According to a preferred embodiment, electronic device 100 is a card configured for implementing a transaction, such as a bank card or a transport card, comprising a screen enabling to display one or a plurality of pieces of information concerning the transaction. According to a first example, the card is a bank card and the screen enables to display a card validation code, also known as CVC code or CVV code. According to a second example, the card is a transport card and the screen enables to display a remaining transport card balance. According to a third example, the card may be a car key, circuit 105 may allow the display or the use of a functionality specific to the use of a car. According to a fourth example, the card may be a smart ticket card or an access control card in which circuit 105 may allow the display of a number of tickets remaining on the card.

It will be noted that a secure element, such as with SE1 or SE2, refers to and is defined to mean in the context described and claimed herein an integrated circuit, for example in the form of a chip, that is by design protected from unauthorized access and used to run a limited set of applications, as well as store confidential and cryptographic data. The secure element functions as a vault providing protection of what is inside the secure element, such as applications and data, from unauthorized access or attack. The secure element protects assets (root of trust, sensitive data, keys, certificates, applications) against high-level software and hardware attacks. Applications that process this sensitive data on a secure element are isolated and so operate within a controlled environment not affected by software (including possible malware) found elsewhere on the system.

In the above description, a secure element is a secure electronic device that is considered to be completely reliable. Said in other words, it is considered impossible to extract data stored and/or used by a secure element. More particularly, a secure element (SE) is a separate chip comprising a secure processor, a tamper-proof storage means, and an execution memory allowing the secure element to execute its tasks without using external memories. This processor is different from the host processor or the computer processor. Its purpose is to allow the implementation of secure operations, such as, for example, secure transactions. This secure element can, for example, implement applications that rely on encryption algorithms and the use of secure keys operating inside this secure processor. A secure element is therefore an inviolable hardware platform, capable of securely hosting applications and storing encrypted confidential data.

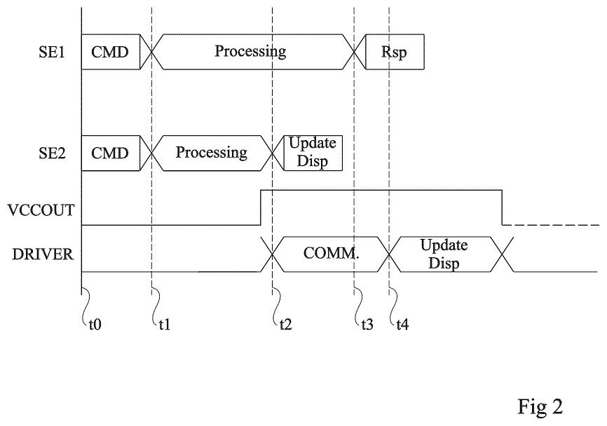

The operation of device 100 is the following. When electronic device 100 implements a transaction with another electronic device, data, for example sensitive data, are received, for example, on terminals 102 and/or antenna 103. These data are transmitted to the two secure elements 101 and 104. The first secure element 101 securely uses the data to effectively implement the transaction. The second secure element 104 securely uses the data to implement, if required, the functionality of circuit 105. FIG. 2 shows a more detailed example the operation of device 100.

An advantage of device 100 is that it enables an electronic device to securely implement a transaction using a first secure element, but also an additional functionality controlled by a second secure element, where this is supported without having to modifying the first secure element implementing said transaction. The second secure element operations in a sort of “spy mode” with respect to the reception and use of the data to control performance of the additional functionality while the first secure element receives and uses the (same) data to perform the secure transaction. An advantage of this configuration is that the first secure element does not need to be burdened with, or include circuit support for, control performance of the additional functionality. Instead, this is effectively offloaded to the second secure element operating in parallel with the first secure element on the same data.

A second advantage of device 100 is that secure element 104 and circuit 105 can be added to already-existing electronic devices having secure element 101, without requiring major modifications to their architecture.

FIG. 2 shows timing diagrams to describe, in greater detail, an operating mode of the device 100 described in relation with FIG. 1.

FIG. 2 shows the following timing diagrams: a timing diagram SE1 showing the variation of the state of the first secure element 101; a timing diagram SE2 showing the variation of the state of the second secure element 104; a timing diagram VCCOUT showing the variation of a power supply voltage of driver circuit 1051; and a timing diagram DRIVER showing the variation of the state of driver circuit 1051.

In an initial time t0, secure elements 101 and 104 receive data concerning a transaction. More particularly, secure elements 101 and 104 receive a command for starting a transaction. Secure elements 101 and 104 are then in a state of reception of a command CMD. Driver circuit 1051 is not powered and is thus not in operation.

At a time t1, following time t0, secure elements 101 and 104 have received the command and enter a command processing state (Processing). This state takes more or less time according to the secure element, since each secure element 101 and 104 processes the received data differently.

According to an example, at a time t2, following time t1, the second secure element 104 finishes processing the command before the first secure element 101. According to an example, the second secure element 104 concludes from the received data that it has to start circuit 105. For this purpose, secure element 104 starts power supply voltage VCCOUT, which thus transits to a high state. Driver circuit 1051 then enters a communication reception state COMM.

According to an example, at a time t3, following time t2, secure element 101 finishes processing the command. According to a variant, times t2 and t3 may be reversed. According to an example, secure element 101 implements the transaction by sending a response, and thus enters a response sending state RSP.

At a time t4, following time t2, driver circuit 1051 is capable of driving circuit 1052, it then enters a control state Update Disp where it can do so. According to an example, if circuit 1052 is a display screen, driver circuit 1051 sends the data required to update the display of circuit 1052.

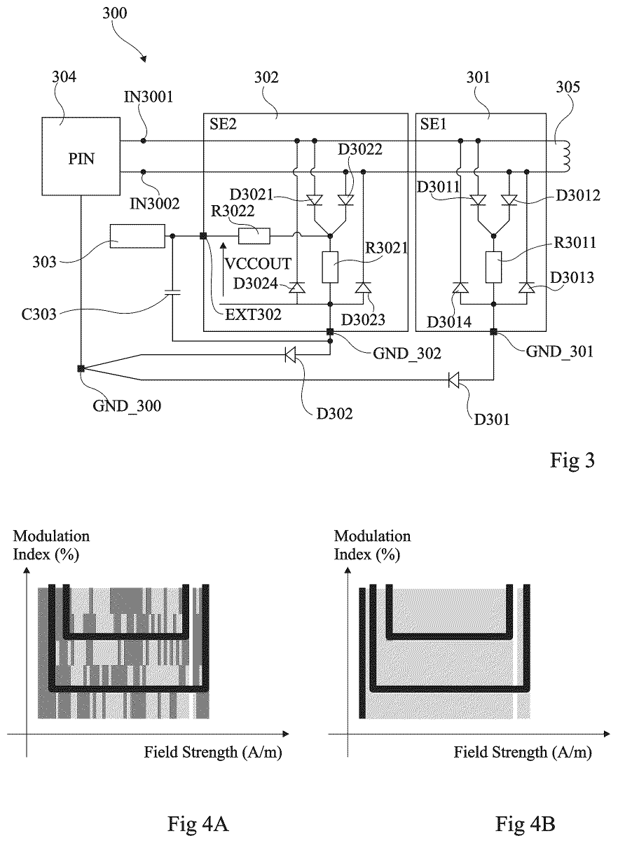

FIG. 3 shows, schematically and partially in the form of blocks, an electronic device 300 (DEVICE) according to an embodiment, of the type of the device 100 described in relation with FIG. 1.

Like device 100, electronic device 300 comprises: a first secure element 301 (SE1), of the type of secure element 101, configured for implementing a transaction; a second secure element 302 (SE2), of the type of secure element 104; a circuit 303, of the type of circuit 105, configured to implement an additional function of device 300, and to be controlled by the second secure element 302; connection terminals 304 (PIN), of the type of connection terminals 102, configured to implement a wired communication; and an antenna 305, of the type of antenna 103, shown in the form of a coil, and enabling to implement a wireless communication.

As in device 100, in device 300, secure elements 301 and 302 are configured to receive the same data. For this purpose, data input nodes IN3001 and IN3002 are coupled to connection terminals 304 and to antenna 305. The first secure element 301 is coupled to input nodes IN3001 and IN3002. Similarly, the second secure element 302 is coupled to input nodes IN3001 and IN3002. Further, connection terminals 304 are further coupled, preferably connected, to a general reference terminal GND_300 of device 300. Reference terminal GND_300 is configured to receive a reference potential, for example the ground.

According to an example, the first secure element 301 comprises four diodes D3011, D3012, D3013, and D3014 and a load R3011 represented by a resistor. According to an example, the anode of diode D3011 is coupled, preferably connected, to node IN3001, and the cathode of diode D3011 is coupled, preferably connected, to a first terminal of load R3011. The anode of diode D30112 is coupled, preferably connected, to node IN3002, and the cathode of diode D3012 is coupled, preferably connected, to the first terminal of load R3011. The cathode of diode D3013 is coupled, preferably connected, to node IN3002, and the anode of diode D3013 is coupled, preferably connected, to a second terminal of load R3011. The cathode of diode D3014 is coupled, preferably connected, to node IN3001, and the anode of diode D3014 is coupled, preferably connected, to the second terminal of load R3011.

According to an embodiment, the first secure element comprises a reference terminal GND_301, coupled, preferably connected, to the second terminal of load R3011. This first reference terminal GND_301 is coupled, preferably connected, to the general reference terminal GND_300 of device 300 via a diode D301. Diode D301 enables the first secure element 301 to have a reference terminal isolated from general reference terminal GND_300. According to an example, diode D301 is a conventional diode. According to a preferred embodiment, diode D301 is a Schottky diode with a lower threshold voltage than a conventional diode.

Further, according to an example, second secure element 302 comprises four diodes D3021, D3022, D3023, and D3024 and a load R3021 represented by a resistor. According to an example, the anode of diode D3021 is coupled, preferably connected, to node IN3001, and the cathode of diode D3021 is coupled, preferably connected, to a first terminal of load R3021. The anode of diode D3021 is coupled, preferably connected, to node IN3002, and the cathode of diode D3022 is coupled, preferably connected, to the first terminal of load R3021. The cathode of diode D3023 is coupled, preferably connected, to node IN3002, and the anode of diode D3023 is coupled, preferably connected, to a second terminal of load R3021. The cathode of diode D3024 is coupled, preferably connected, to node IN3001, and the anode of diode D3024 is coupled, preferably connected, to the second terminal of load R3021.

According to an embodiment, the second secure element comprises a reference terminal GND_302, coupled, preferably connected, to the second terminal of load R3021. This second reference terminal GND_302 is coupled, preferably connected, to the general reference terminal GND_300 of device 300 via a diode D302. Diode D302 enables the second secure element 302 to have a reference terminal isolated from the general reference terminal GND_300, and from the reference terminal GND_301 of the first secure element. According to an example, diode D302 is a conventional diode. According to a preferred embodiment, diode D302 is a Schottky diode.

According to an example, the second secure element further comprises a resistor R3022 coupling the first terminal of load R3021 to a terminal EXT302. Terminal EXT302 is a terminal of the second secure element 302 coupled, preferably connected, to circuit 303 to supply it with a power supply voltage VCCOUT or a control voltage. According to an example, power supply voltage VCCOUT is taken between the terminal EXT302 and the reference terminal GND_302 of secure element 302.

According to an example, the input of circuit 303 is coupled to the terminal EXT302 of the second secure element 302, but also to reference terminal GND_302 via a filtering capacitor C303.

FIGS. 4A-4B show diagrams illustrating an advantage of the circuit 300 described in relation with FIG. 3.

As previously described, secure elements 301 and 302 have their reference terminals GND_301 and GND_302 isolated from each other, and isolated from the general reference terminal GND_300 of device 300.

FIGS. 4A-4B show the state of the implemented wireless communication according to the variation of the modulation index of a wireless communication with respect to the power of the electromagnetic field generated by a reader and used by this wireless communication. A dark box represents a wireless communication that could not be implemented, and a light box represents a wireless communication that could be implemented.

FIG. 4A shows the case where reference terminals GND_301 and GND_302 are not isolated from each other, and from the general reference terminal GND_300 of device 300. FIG. 4B shows the case where reference terminals GND_301 and GND_302 are isolated from each other, and from the general reference terminal GND_300 of device 300.

There clearly appears that the two secure elements 301 and 302 can interfere in the received communications, and that isolating their conduction terminals enables to improve external communications.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. An electronic device, comprising:
a first electronic circuit configured to implement a functionality;
a first secure element configured to receive data and implement a transaction; and
a second secure element configured to receive the same data as the first secure element and control operation of the first electronic circuit to implement the functionality.

2. The device according to claim 1, wherein the first and second secure elements are configured to receive the data by wired communication.

3. The device according to claim 2, wherein the first and second secure elements are coupled to same connection terminals configured to receive the data by the wired communication.

4. The device according to claim 1, wherein the first and second secure elements are configured to receive the data by a wireless communication.

5. The device according to claim 4, wherein the first and second secure elements are coupled to a same antenna configured to receive the data by the wireless communication.

6. The device according to claim 4, wherein the wireless communication is a near-field communication.

7. The device according to claim 1, further comprising a reference terminal of the electronic device and a first diode configured to couple a first reference terminal of the first secure element to said reference terminal of the electronic device.

8. The device according to claim 7, wherein the first diode is a Schottky-type diode.

9. The device according to claim 7, further comprising a second diode configured to couple a second reference terminal of the second secure element to said reference terminal of the electronic device.

10. The device according to claim 9, wherein the second diode is a Schottky-type diode.

11. The device according to claim 9, wherein said first electronic circuit comprises a fourth terminal coupled to said second reference terminal via a capacitor.

12. The device according to claim 1, wherein said first electronic circuit comprises a second circuit and a third circuit configured to drive said second circuit.

13. The device according to claim 12, wherein the second circuit is selected from a group consisting of: a display screen, a fingerprint sensor, a light-emitting diode, a sensor control device, and a memory.

14. The device according to claim 1. wherein said device comprises one of: a bank card. a smart transport card, a car key. an access control card.

15. An electronic device, comprising:
an antenna having first and second terminals;
a first secure element including: a first diode with an anode connected to the first terminal;
a second diode with an anode connected to the second terminal; and a load of the first secure element connected between a first ground node and common cathodes of the first and second diodes;
a second secure element including: a third diode with an anode connected to the first terminal; a fourth diode with an anode connected to the second terminal; a load of the second secure element connected between a second ground node and common cathodes of the third and fourth diodes; and a third resistor connected between a power supply output node and the common cathodes of the third and fourth diodes; and
an electronic circuit configured to implement a functionality and having a power supply input connected to the power supply output node.

16. The device according to claim 15, further comprising:
a fifth diode connected between a common ground node and the first ground node; and
a sixth diode connected between a common ground node and the second ground node.

17. The device according to claim 15, further comprising a capacitor connected between the input node and the second ground node.

18. The device according to claim 15, wherein said electronic circuit comprises a functional circuit and a driver circuit configured to drive said functional circuit.

19. The device according to claim 18, wherein the functional circuit is selected from a group consisting of: a display screen, a fingerprint sensor, a light-emitting diode, a sensor control device, and a memory.

20. The device according to claim 15, wherein said device comprises one of: a bank card, a smart transport card, a car key, an access control card.
